(19) United States
(12) Patent Application Publication
(10) Pub. No.: US 2003/0058110 A1
(43) Pub. Date: Mar. 27, 2003

(54) Radio frequency patient identification and information system

(76) Inventor: Michael John Rich, Lindon, UT (US)

Correspondence Address: Angus C. Fox, III, 4093 North Imperial Way, Provo, UT, 84604-5386, US

(21) Appl. No.: 09/967,565

(22) Filed: Sep. 27, 2001

(51) Int. Cl. G08B 23/00

(52) U.S. Cl. 340/573.1; 340/572.1; 340/5.8

(57) ABSTRACT

A radio frequency patient identification and information system includes a transponder which may be incorporated in a device which may be strapped to a patient's wrist or ankle, or hung around the patient's neck by a cord, carried as a card or label in the patient's purse or wallet, or embedded under the patient's skin. The transponder, in the form of an RFID tag, operates at a frequency standardized for this application, has a read/write memory of about at least two thousand bits—an amount sufficient to store information related to the patient's complete identification, such as home address, work address, next of kin, the patient's current primary care physicians, important contact telephone numbers, insurance information, complete medical history, all known allergies, and past and presently-prescribed medicines. The tag may be equipped with a transmission enable switch to prevent unauthorized access to the patient's medical history and other potentially sensitive information. An interrogator/reader/writer device is provided at each emergency health care facility and at the office of each health care provider.

### BACKGROUND OF THE INVENTION

1. Field of the Invention

The present invention relates to medical alert bracelets and to radio frequency based transponders in general and, more particularly, to radio frequency identification tags having a read/write memory.

2. Description of the Prior Art

Transponders were originally developed during World War II for use as IFF (Identify Friend or Foe) devices on aircraft so that they could be identified by radar operators. Only friendly aircraft were capable of providing a proper response to secret preprogrammed interrogation codes transmitted by an interrogator device.

After the war, another important use for transponder-based, radio frequency identification (RFID) was implemented in the field of aviation. In response to an interrogator signal, an aircraft transponder returns an identification number (commonly called a “squawk code”) and an encoded altitude value so that radar controllers can track the identity, the altitude and the location (determined by a reflected radar signal) of each aircraft in controlled airspace.

As a general rule, an interrogator transmits a very powerful signal and the transponder responds with a significantly weaker signal. Thus, if both the interrogator and the transponder are operating on the same radio frequency, the response of the latter will be swamped by the former. One of two basic techniques is generally used to avoid this problem. The first is to utilize different frequencies for interrogations and responses. If the two frequencies are sufficiently well separated, they will not interfere with one another. The second is to time share the same frequency. Using the latter technique, the interrogator sends an interrogation signal for a fixed length of time and then reverts to silence for an additional fixed length of time. The transponder receives the interrogation signal, waits until the interrogation signal terminates, and then responds with a programmed response during the interrogator's silent period.

Within the past decade, the development of microelectronics has made possible the use of transponder systems for electronic identification. Such transponder systems are often referred to as RFID tags, as it is generally assumed that their primary end application will be that of tagging a variety of goods. For such applications, the tags are manufactured as cheaply and simply as possible, and every attempt is made to pack any required complexity, as well as tag control functions into the interrogators (which are typically referred to as readers). In the interest of cost savings and miniaturization, RFID tags are generally manufactured as an integrated circuits. Like other integrated circuits, RFID tags are becoming increasingly more powerful. Today, RFID tags with up to 32 kilobytes of read/write memory are available.

An explanation of how a radio frequency identification tag works is in order. Referring now to FIG. 1, a proximity interrogation system 100 includes an interrogator or reader 101, a transponder (an “RFID tag”) 102, and a data processing terminal and/or computer system 103. The reader 101 generally includes a micro-controller 104, a transmitter 105, a receiver 106, and a shared transmit/receive antenna 107. The tag 102 is typically passive (having no on-board power source, such as a battery) and includes at least an antenna 108 (generally configured as a coil), and an application specific integrated circuit (ASIC) 109. As the tag 102 receives its operational energy from the reader 101, the two devices must be in close proximity. Within what is termed the surveillance zone, the reader generates sufficient power to excite the tag 102. When radio frequency energy emanating from the reader's antenna 107 impinges on the tag 102 while it is in the surveillance zone, a current is induced in the coil of antenna 108. This induced current is routed to the ASIC 109, which then performs an initialization sequence. When the reader 101 ceases transmitting its energy transmitting interrogation signal, the ASIC begins to broadcast its identity and any other requested information over the tag antenna 108. The tag transmission process utilizes low-energy transmission technology that selectively reflects the electromagnetic energy back to the reader at the same fundamental frequency as it was received, using the tag antenna 108 as an energy radiator. The transmit/receive frequency employed is generally application dependent. Commonly available proximity interrogation systems operate at frequencies in a range of 60 kHz to 5.8 GHz, and typically employ frequency modulation for data transmission. Information reflected by the tag 102 is decoded by the reader 101.

In the healthcare field, there is an increasing need for effective and rapid identification of individuals who may suffer episodes of unconsciousness or semiconsciousness. Individuals afflicted with diabetes, epilepsy, and many other life-threatening diseases typically wear an identification bracelet having a critical medical information inscribed thereon. Other individuals with other than life threatening medical conditions may desire to have constant access to their medical records for travel outside their residence city. With the increasing incidence of obesity-triggered diabetes in society, the need for wearable devices which provide patient identification and medical information is certain to increase. Clearly, the more quickly an emergency medical team obtains access to critical medical information of an unconscious individual, the more quickly the team will be able to provide an appropriate response to the medical condition, and the greater the likelihood that permanent physical disability, or even death, will be averted.

### SUMMARY OF THE INVENTION

The present invention provides a method and apparatus for storing, reading and updating personal medical information carried by an individual and for quickly identifying a patient in the event of an medical emergency situation, and providing an emergency medical team with immediate access to critical medical information concerning the patient. The method and apparatus make use of existing RFID tags, many of which can be adapted for installation in a device which can be worn about the patient's wrist or neck, carried in a wallet or purse in the form of a card or label, or even embedded beneath an individuals skin. The appropriate RFID tag operates at a frequency standardized for this application, preferably has a read/write memory sufficient to store information related to the patient's complete identification, such as home address, work address, next of kin, the patient's current primary care physicians, important contact telephone numbers, insurance information, complete medical history, all known allergies, and past and presently-prescribed medicines. For most individuals, a read/write memory of about 16 kilobits, which provides storage for about two thousand ASCII characters, is ample. Nevertheless, the system may be implemented by storing only essential identification information and encoded medical information with as little as 2 kilobits.

An interrogator/reader/writer device is provided at each emergency health care facility and at the office of each health care provider. Any time the patient visits a health care provider, whether for regularly scheduled appointments or for emergency treatment, the provider may update the information stored within the read/write memory of the patient's RFID tag.

It is deemed desirable to prevent unauthorized access to an individual's medical records. Accordingly, the medical information tag may be equipped with an optional transmission enable feature. Transmission capability may be enabled by either a physical switch on the tag or with a pin code that can be transmitted by an interrogator and received by the tag. A physical switch is generally maintained in a transmission disabled state to prevent unauthorized access to the patient's medical history and other potentially sensitive information. The transmission enable switch may be activated by either a conscious patient or, in the case of an ill or unconscious patient, an attending healthcare provider. For externally worn tags, either system may be implemented. However, for an embedded tag, a pin code enable system is more practical. Such a pin code might be worn by the patient on a bracelet or necklace tag. Once a tag's transmission capability is enabled, all information concerning the individual can be downloaded to a health facility's computer system for viewing and/or storing.

### BRIEF DESCRIPTION OF THE DRAWINGS

FIG. 1 is a block diagram of a proximity interrogation system;

FIG. 2 is a block diagram of a first embodiment transponder employed by the present invention;

FIG. 3 is a block diagram of a second embodiment transponder employed by the present invention;

FIG. 4 is a block diagram of a third embodiment transponder employed by the present invention;

FIG. 5 is a cross-sectional view of a transponder embedded beneath a patient's skin in the subcutaneous layer;

FIG. 6 is a plan view of a transponder embedded in a credit card sized sheet of polymeric material; and

FIG. 7 is a plan view of a transponder embedded in an article designed to be worn about the wrist or ankle.

### PREFERRED EMBODIMENT OF THE INVENTION

The present invention provides a method and apparatus for storing, reading and updating personal medical information carried by an individual, for quickly identifying a patient in the event of an medical emergency situation, and providing an emergency medical team with immediate access to critical medical information concerning the patient. The method and apparatus make use of proximity interrogation systems and existing RFID tags, many of which can be adapted for installation in a device which can be worn about the patient's wrist or neck, carried in a wallet or purse in the form of a card or label, or even embedded beneath an individuals skin. Commonly available proximity interrogation systems operate at frequencies in a range of 60 kHz to 5.8 GHz. Clearly, for the intended application, the operational frequency should be standardized so that the equipment required to set up a wide spread system is minimized. For the application, the RFID tag preferably has a read/write memory sufficient to store information related to the patient's complete identification, such as home address, work address, next of kin, the patient's current primary care physicians, important contact telephone numbers, insurance information, complete medical history, all known allergies, and past and presently-prescribed medicines. For most individuals, a read/write memory of about 16 kilobits, which provides storage for about two thousand ASCII characters, is ample. Nevertheless, the system may be implemented by storing only essential identification information and encoded medical information with as little as 2 kilobits.

An interrogator/reader/writer device is provided at each emergency health care facility and at the office of each health care provider. Any time the patient visits a health care provider, whether for regularly scheduled appointments or for emergency treatment, the provider may update the information stored within the read/write memory of the patient's RFID tag.

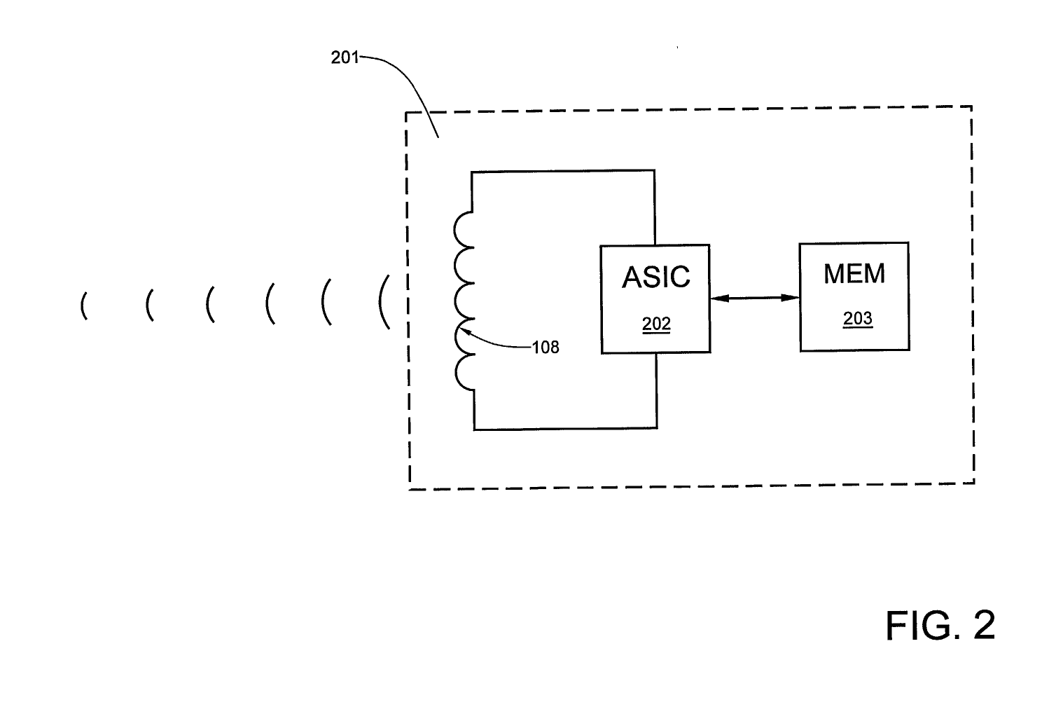

Several embodiments of a transponder for use in a medical patient identification and information retrieval system will now be described with reference to drawing FIGS. 2 through 4.

Referring now to FIG. 2, a first embodiment transponder 201 includes an application specific integrated circuit (ASIC) 202 that is bidirectionally coupled to a read/write memory 203. The ASIC 202 is also coupled to an antenna 108 that is used for both reception and transmission. In order to simplify the design and manufacture of the ASIC 202, a single frequency is employed for both reception and transmission. In order to prevent an individual's medical or other sensitive information from being accessed by unauthorized individuals, the transponder 201 may be stored in a foil envelope when access is not required.

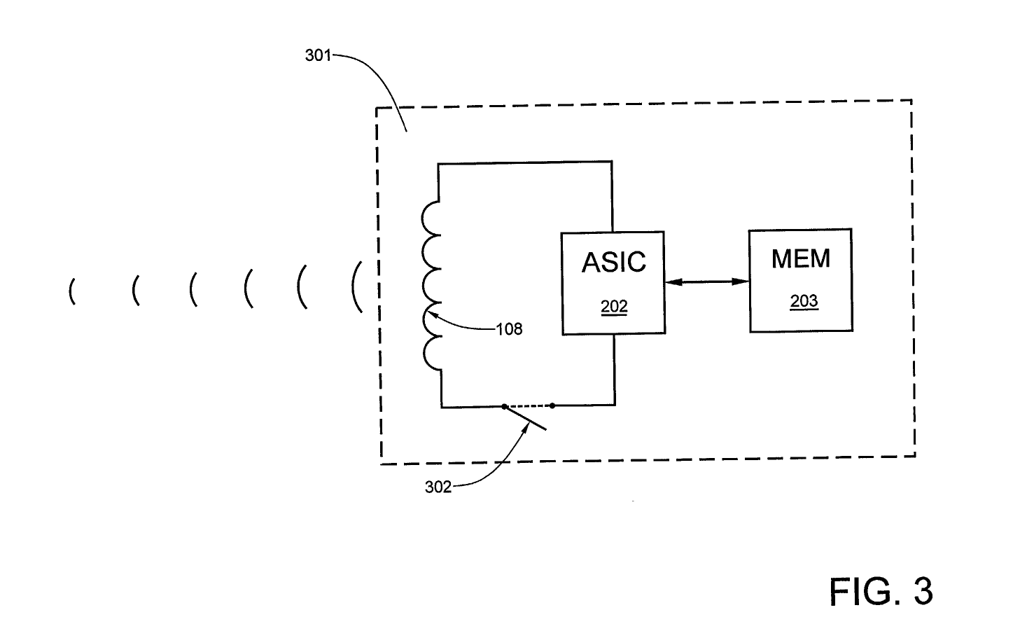

Referring now to FIG. 3, a second embodiment transponder 301 is similar to that of FIG. 2, with the exception that a manually-operable receive and transmission enable switch 302 is placed in series with the antenna 108. Unless the switch 302 is in the closed-circuit position (shown by the dashed line), no reception or transmission is possible. Thus, the likelihood of an individual's medical or other sensitive information being accessed by an unauthorized individual is minimized.

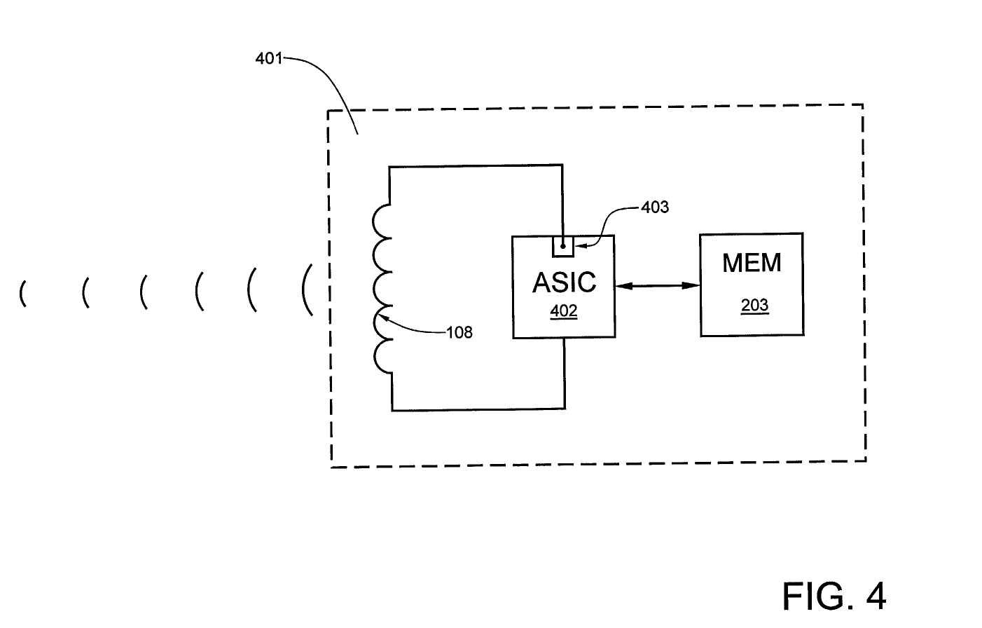

Referring now to FIG. 4, a third embodiment transponder 401 incorporates a transmission enable switch 403 in the ASIC 402. Only transmission—not reception—may be disabled, as the ASIC must receive a security code from an interrogator that matches a programmed security code stored in a register of the ASIC. A security code match will result in the enable switch 403 being activated so that information from the memory 203 can be sent to the interrogator.

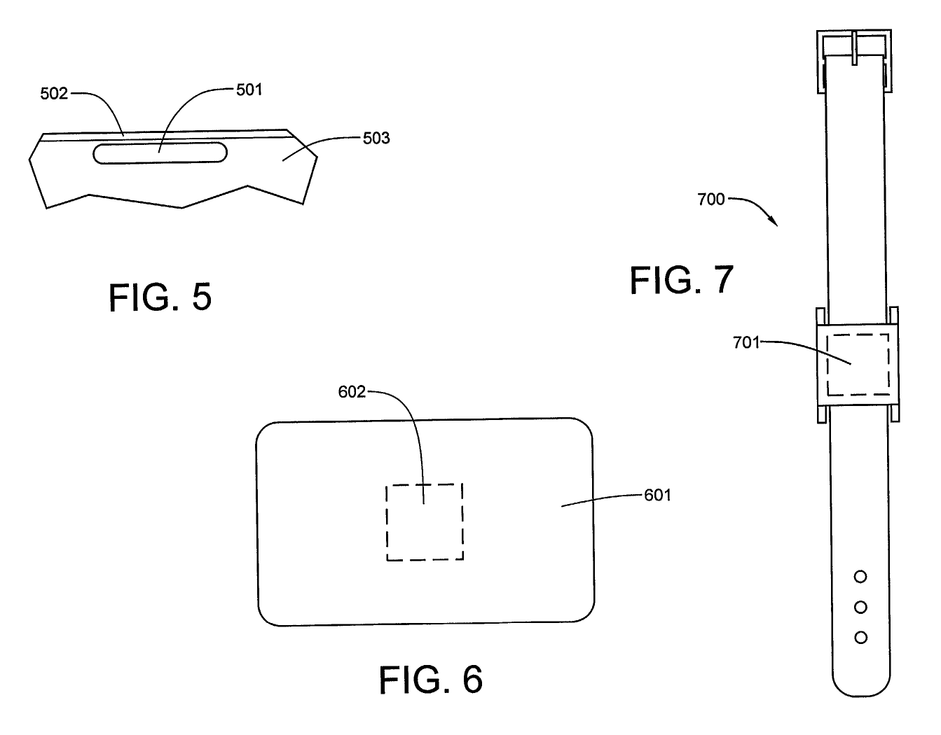

Referring now to FIG. 5, a transponder 501 is embedded beneath a patient's skinn 502 within a subcutaneous layer 503.

Referring now to FIG. 6, a transponder 602 is embedded in a credit card shaped and sized sheet of laminar polymeric plastic material.

Referring now to FIG. 7, a transponder 701 is incorporated in a watch-like device 700 designed to be worn about the wrist or ankle.

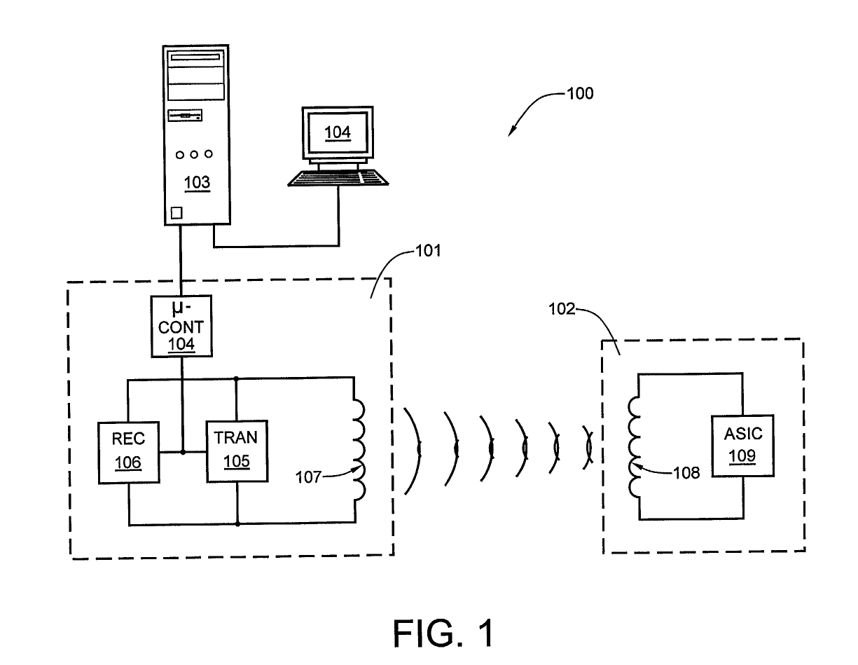

The interrogator used for the present invention may be of the type shown in FIG. 1, and it may be coupled to a computer 103 and/or a data terminal. Information stored in the memory 203 of any of the first, second and third embodiment transponders (201, 301 or 401, respectively) may be updated when within range of an interrogator 101 operating on the proper frequency.

Although only several embodiments of the patient identification and iformation retrieval system have been heretofore described, it will be obvious to those having ordinary skill in the art that changes and modifications may be made thereto without departing from the scope and the spirit of the invention as hereinafter claimed.

What is claimed is:

1. A medical patient identification and information retrieval system comprising:
a transponder wearable by the patient, said transponder operable on at least one standardized frequency of the electromagnetic spectrum, said transponder having a memory of sufficient size for storage of information related to the patient's identification and medical history,
an interrogator/reader installable at both emergency and non-emergency medical care facilities, said interrogator/reader/writer having the capability to interrogate the patient's transponder and command the transponder to transmit to it information stored within the read/write memory for display to medical personnel.

2. The medical patient identification and information retrieval system of claim 1, wherein said interrogator/reader is also a writer, and said memory is both readable and writable by said interrogator.

3. The medical patient identification and information retrieval system of claim 1, wherein said memory stores information digitally and has a capacity of at least two thousand bits.

4. The medical patient identification and information retrieval system of claim 1, wherein said transponder is embeddable beneath the patient's skin.

5. The medical patient identification and information retrieval system of claim 1, wherein said transponder is encapsulated within a polymeric card of the same general shape and size as a common credit card.

6. The medical patient identification and information retrieval system of claim 1, wherein said transponder is incorporated in a bracelet or like piece of wearable jewelry.

7. The medical patient identification and information retrieval system of claim 1, wherein said transponder is equipped with a transmission enable feature, the function of which is to decrease the likelihood that an individual's medical history or other sensitive information will be accessed by unauthorized individuals.

8. The medical patient identification and information retrieval system of claim 7, wherein said transmission enable feature is a foil envelope, in which the transponder is stored during non use, and from which the transponder is removed to expose an on-board antenna for use.

9. The medical patient identification and information retrieval system of claim 7, wherein said transmission enable feature is a physical switch on an externally worn transponder activatable by either the patient or a health care provider.

10. The medical patient identification and information retrieval system of claim 7, wherein said transmission enable feature is a switch internal to the transponder that is activatable upon receipt by the transponder of a security code transmitted by an interrogator for reception and recognition by the tag.

11. The medical patient identification and information retrieval system of claim 10, wherein said pin code is transmitted and received as encoded serial digital data.

12. A medical patient identification and information retrieval system comprising:
a transponder wearable by the patient, said transponder providing reception and transmission on a single standardized frequency of the electromagnetic spectrum, said transponder having a memory of sufficient size for storage of information related to the patient's identification, his insurance coverage, the name of at least his primary care physician, important contact telephone numbers, his medical history, all known allergies, and presently-prescribed medicines;
an interrogator/reader installable at both emergency and non-emergency medical care facilities, said interrogator/reader/writer having the capability to interrogate the patient's transponder and command the transponder to transmit to it information stored within the read/write memory for display to medical personnel.

13. The medical patient identification and information retrieval system of claim 12, wherein said interrogator/reader is also a writer, and said memory is both readable and writable by said interrogator.

14. The medical patient identification and information retrieval system of claim 12, wherein said memory stores information digitally and has a capacity of at least two thousand bits.

15. The medical patient identification and information retrieval system of claim 12, wherein said transponder is embeddable beneath the patient's skin.

16. The medical patient identification and information retrieval system of claim 12, wherein said transponder is incorporated in a device for which is carried on or attached to the patient's body.

17. The medical patient identification and information retrieval system of claim 12, wherein said transponder further comprises a transmission enable switch, that can be activated by the patient or medical care personnel to prevent unauthorized access to the patient's medical history and other potentially sensitive information.

18. The medical patient identification and information retrieval system of claim 17, wherein said transmission enable feature is a physical switch on an externally worn transponder activatable by either the patient or a health care provider.

19. The medical patient identification and information retrieval system of claim 17, wherein said transmission enable feature is a switch internal to the transponder that is activatable upon receipt by the transponder of a security code transmitted by an interrogator for reception and recognition by the tag.

20. The medical patient identification and information retrieval system of claim 19, wherein said pin code is transmitted and received as encoded serial digital data.
